(19) United States
(12) Patent Application Publication
(10) Pub. No.: US 2006/0230153 A1
(43) Pub. Date: Oct. 12, 2006

(54) Network communication using push technology

(75) Inventor: Rong Li, Weston, FL (US)

Correspondence Address: BOURQUE & ASSOCIATES;INTELLECTUAL PROPERTY ATTORNEYS, P.A., 835 HANOVER STREET, SUITE 301, MANCHESTER, NH, 03104, US

(73) Assignee: CIM, Ltd., Westford, MA (US)

(21) Appl. No.: 11/103,087

(22) Filed: Apr. 11, 2005

(51) Int. Cl. G06F 15/16

(52) U.S. Cl. 709/227

(57) ABSTRACT

A system and method for managing a network connection using a connectionless, file-transferring protocol is disclosed. The exemplary method periodically transmits a browser executable script from a first node of a network to a second node of the network. A browser of the second node runs the browser executable script and transmits an information request from the second node to the first node. The transmitting of information requests from the second node maintains a communication link with the first node and the second node until a trigger event occurs.

### TECHNICAL FIELD OF THE INVENTION

The present invention relates to the field of network communication, and, more particularly, to a method and system for managing a network connection using a connectionless, file-transferring protocol.

### BACKGROUND

Email provides a mode of communication for interaction between two or more parties using text messages. A first user sends a text message to a second user. The second user receives the message and may send a responding text message to the first user. The text conversation goes back and forth and allows the two users to effectively communicate information between each other.

However, email requires a time delay between the first user sending a message and the second user receiving the message. In addition, the first user may want to send an additional thought before the second user responds to the first user's original thought. Using email, the second user may have already typed a response to the original email of the first user, or worse, already sent the response. The delay required for transferring emails may prevent a real time dialogue between the first user and second user.

Web chat allows the first and second user to view the messages as the users enter them. This allows a user to respond immediately to a thought of the other user. The first user may immediately view the message as the second user types in the message. Web chat requires that a line of communication be established between the users' computers.

Traditionally, a first computer of the first user establishes a link to a server and transmits the messages to the server. The first computer then continually sends the Uniform Resource Locator (URL) of the server to a second computer of the second user. The second computer responds to the sent URL and establishes a communication link with the server. The second computer receives and transmits messages to the server. The first computer continually sends messages or URLs and requires the second computer to go to the designated URL or retrieve the message. This is conventionally termed pull technology.

Push technology prearranges for updating of the information on the first computer and the second computer through periodic communication links with the server. The prearranged updating is accomplished with software, such as, ActiveX® control. The user downloads the additional software, which runs in the background providing for periodic polling of the server or other user's computer. Regular periodic polling of the server may not be efficient during periods of high network usage. The polling may not retrieve new information every time and may cause unnecessary congestion. In addition, the user must download autonomous software and may raise security issues for the first computer and the second computer. Therefore, there is a need for an effective and efficient method and system for managing a network connection using a connectionless, file-transferring protocol.

### SUMMARY OF THE INVENTION

The present invention is a novel system and method for managing a network connection using a connectionless, file-transferring protocol. An exemplary system and method of the present invention periodically transmits a browser executable script from a first node on a network to a second node of the network. The browser of the second node runs the browser executable script. The second node transmits an information request to the first node. The information request maintains a communication link between the first node and the second node until a trigger event occurs.

According to one aspect, a uniform resource locator of the first node is a parameter of the browser executable script. In another aspect, the connectionless, file-transferring protocol is hypertext transfer protocol. In yet another aspect, the browser executable script is a Javascript function. The network connection may also be used for a web chat session. The trigger event may be an amount of time, a command provided by a user of the network connection, or a request by the first node.

It is important to note that the present invention is not intended to be limited to a system or method which must satisfy one or more of any stated objects or features of the invention. It is also important to note that the present invention is not limited to the preferred, exemplary, or primary embodiment(s) described herein. Modifications and substitutions by one of ordinary skill in the art are considered to be within the scope of the present invention, which is not to be limited except by the following claims.

### BRIEF DESCRIPTION OF THE DRAWINGS

These and other features and advantages of the present invention will be better understood by reading the following detailed description, taken together with the drawings wherein:

FIG. 1 is a system diagram of an exemplary network used to implement the present invention.

FIG. 2 is a flow chart illustrating a first exemplary embodiment according to the present invention.

FIG. 3 is a flow chart illustrating a second exemplary embodiment according to the present invention.

FIG. 4 is a flow chart illustrating a third exemplary embodiment according to the present invention.

### DETAILED DESCRIPTION

The present invention features methods and systems for managing a network connection using a connectionless, file-transferring protocol. The methods and systems of the invention provide a network connection between two or more computers without the need of additional software for maintaining the communication link. The methods and systems use push technology and browser executable scripts to maintain a communication link.

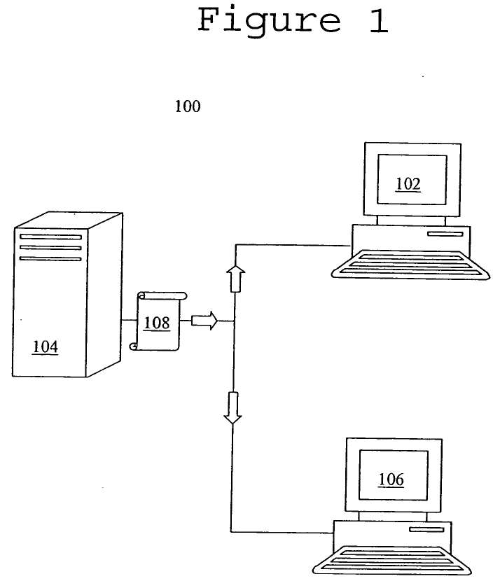

FIG. 1 is a system diagram of a communication network 100 used for efficiently providing a communication link between a first computer 102 of a first user and a second computer 104 of a second user. The first computer 102 transmits a request to a server 104 to establish a link with the second computer 106. The server 104 may transmit a request to the second computer 106 to determine if the user of the second computer 106 would like to establish a communication link with the first computer 102.

If the second computer 106 would like to establish the communication link, the server 104 begins transmitting browser executable scripts 108 to both the first computer 102 and the second computer 106. A first browser on the first computer 102 receives the browser executable script 108 and executes the script 108. The browser executable script 108 instructs the first browser to retrieve information located on the server 104. Correspondingly, a second browser on the second computer 106 also receives the browser executable script 108 and executes the script 108. The browser executable script 108 instructs the second browser to retrieve information located on the server 104.

The server periodically sends the browser executable script 108 to both the first computer 102 and the second computer 106. The continual execution of the received browser executable script 108 maintains a connection between the first computer 102 and the server 104 and the second computer 106 and the server 104. In addition to polling the server 104 to retrieve information, the first computer 102 and the second computer 106 may also transmit information to the server 104.

For example, if the communication link is intended to provide the first computer 102 and the second computer 106 with the ability to web chat, the first computer 102 and second computer 106 may transmit textual messages to the server 104 as their respective users enter the textual message. The first computer 102 transmits to the server 104 increments of a text message destined for the second computer 106. The server 104 sends a browser executable script 108 to the second computer 106. The second browser of the second computer 106 responds to the browser executable script 108 and retrieves the increments of the text message from the server 104. As each increment of the text message is sent to the server 104 and the second computer 106 receives and executes the browser executable script 108 from the server 104, the second computer 106 receives and displays the increments of the text message from the first computer 102.

The second user may respond to the text message and send a response text message to the server 104. As the second user enters the response text message, the second computer 106 transmits increments of a text message destined for the first computer 102 to the server 104. Correspondingly, the server 104 sends a browser executable script 108 to the first computer 102. The first browser of the first computer 102 responds to the browser executable script 108 and retrieves the increments of the response text message from the server 104. As each increment of the response text message is sent to the server 104 and the first computer 102 receives and executes the browser executable script 108 from the server 104, the first computer 102 receives and displays the increments of the response text message from the second computer 106.

The invention uses push technology and browser executable script to maintain a communication link allowing one or more computers to communicate in real time without the need for additional software installation or compromising security of the one or more computers. The invention provides a network connection using a connectionless, file-transferring protocol. Examples of the protocol may include Hypertext Transfer Protocol (HTTP). HTTP is the set of rules for transferring files (text, graphic images, sound, video, and other multimedia files) on the World Wide Web. Other file-transferring protocols that runs on top of the TCP/IP suite of protocols may be used to implement aspects of the invention as well. The browser executable script may be written in a variety of programming languages, for example, but not limited to Java.

The script may be executable by a browser, for example, but not limited to Explorer®, Netscape®, or Firefox®. The browser executable script may be a function that calls a parameter specific to the information being retrieved. For example, the parameter may be the Uniform Resource Locator (URL) of the server 104 storing the information or processing the requests. The server may send the same function to different computers with different URL as parameters depending on the location of the stored information relevant to the computer receiving the function. In this example, the function may be sent by another computer or server on the network, while the information is stored on yet another computer or server on the network.

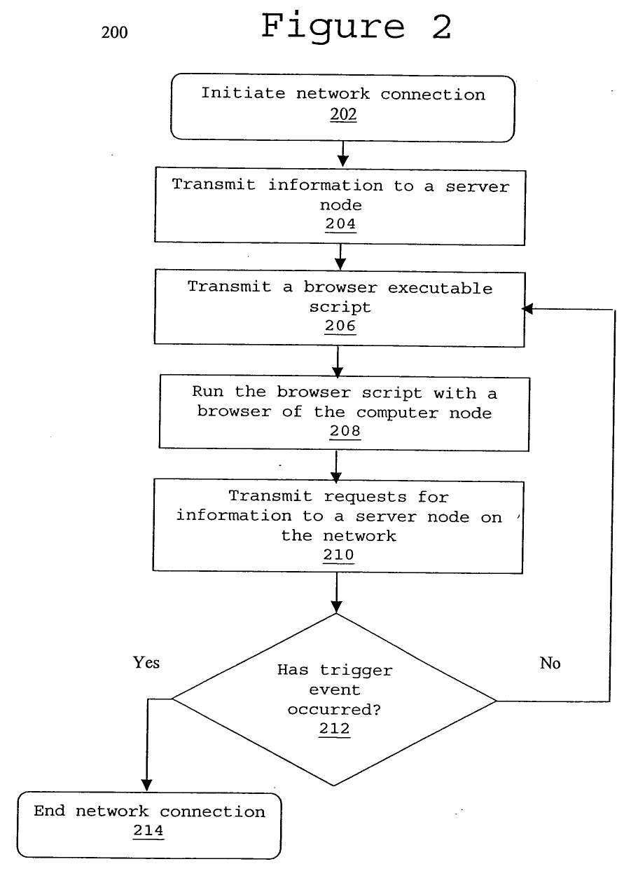

FIG. 2 is a flow chart illustrating a first exemplary embodiment 200 according to the present invention. The first exemplary embodiment 200 illustrates an exemplary method used for providing a network connection using a connectionless, file-transferring protocol between a computer node, for example a desktop, laptop, or other equipment on the network and a server node. The computer node or server node on the network initiates the network connection (block 202). The computer node transmits information to the server node requesting a network connection (block 204). The server node transmits a browser executable script to the computer node in response to the network request (block 206). The browser on the computer node runs the browser executable script (block 208). The browser executable script may provide requested information and causes the computer node to request additional information from the server node on the network (block 210). The requested information may be an increment of a text message, for example, but not limited to, the latest retrieved text entry from another computer node or the latest retrieved game movement entry from another computer node. The browser executable script also may not provide any new information. For example, if the latest entry has been transmitted previously to the computer node, the browser executable script may not provide any new information but may be used to maintain the communication connection.

The server node determines if a trigger event has occurred (block 210). A trigger event is an event that signals to the server node that the communication link is no longer needed and to end the communication link. Examples of trigger events may include but are not limited to, an amount of time, a command provided by a user of the network connection, and a request by a node of the network. If a trigger event has not occurred (“No” branch from block 210), the server node transmits another browser executable script to the computer node (block 206). Correspondingly, the browser of the computer node runs the browser executable script (block 208) providing information and causing transmission of another request for information to the server node (block 210). The server again determines if a trigger event has occurred (block 210). If a trigger event still has not occurred (“No” branch from block 210), the server node transmits another browser executable script and cycles back through the loop. If a trigger event has occurred, for example, the user of the computer node wishes to end the network connection (“Yes” branch from block 210), the server node ends the transmission loop and allows the network connection to end (block 212). The server may also send additional instructions or messages to the computer node or other nodes communicating the ending of the network connection. The first exemplary embodiment 200 illustrates an exemplary method used for providing a network connection between a computer node and a server node.

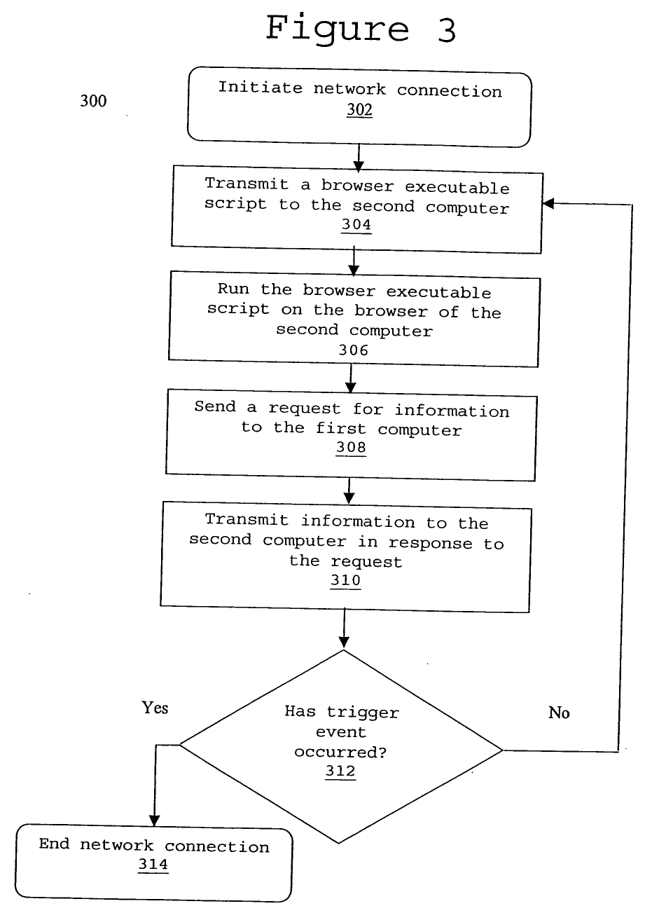

FIG. 3 is a flow chart illustrating a second exemplary embodiment 300 according to the present invention. The second exemplary embodiment 300 illustrates an exemplary method used for providing a network connection using a connectionless, file-transferring protocol between a first computer and a second computer. The first computer or the second computer initiates the network connection (block 302). The first computer transmits a browser executable script to the second computer (block 304). The browser on the second computer runs the browser executable script (block 306). The browser of the second computer sends a request for information to the first computer (block 308). Similar to the first exemplary embodiment, the requested information may be an increment of a text message or other information. The first computer may transmit the requested information to the second computer (block 310). The request also may not retrieve any new information but may be used to maintain the communication connection between the first computer and the second computer.

The first computer determines if a trigger event has occurred (block 312). Similar to the first exemplary embodiment, a trigger event is an event that signals to the first computer that the communication link is no longer needed and to end the communication link. If a trigger event has not occurred (“No” branch from block 312), the first computer transmits another browser executable script and cycles back through the loop. If a trigger event has occurred, for example, the user of the second computer wishes to end the network connection (“Yes” branch from block 312), the first computer ends the transmission loop and allows the network connection to end (block 314). The first computer may also send additional instructions or messages to the second computer confirming the user's intentions to end the network connection.

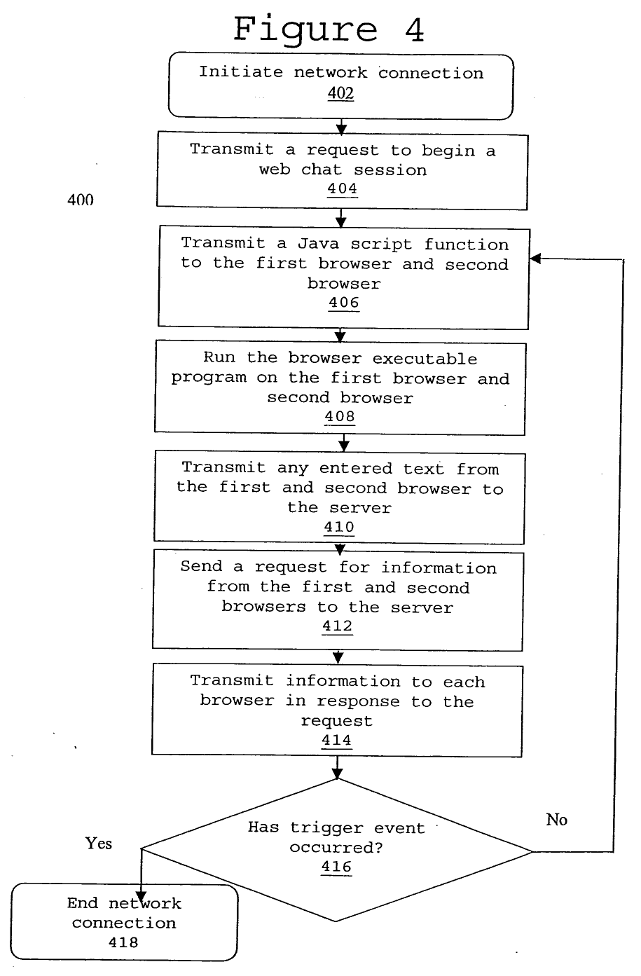

FIG. 4 is a flow chart illustrating a third exemplary embodiment 400 according to the present invention. The third exemplary embodiment 400 illustrates an exemplary method used for providing a web chat connection using HTTP protocol between a first computer and a second computer. The first computer and the second computer connect to a server to initiate a network connection (block 402). The first computer and the second computer send requests to the server to begin a web chat session (block 404). The server transmits a Javascript function with the URL of the server as a parameter of the Javascript function to a first browser of the first computer and a second browser of the second computer (block 406). The browsers on the first computer and second computer run the Javascript function (block 408). The Javascript function instructs the browsers to request text entries from the URL of the server. The first browser and the second browser transmit any entered text by their perspective users to the server (block 410). The first computer and the second computer also request any entered text from the other browser (block 412). The request is sent to the URL parameter of the Javascript function. The server sends any updated text to the respective browsers (block 414).

The server determines if a trigger event has occurred (block 416). If a trigger event has not occurred and both users of the first computer and second computer wish to continue the web chat session (“No” branch from block 416), the server transmits another Javascript function to the first browser and the second browser and cycles back through the loop. If a trigger event has occurred, for example, the user of the first computer or the second computer wishes to end the network connection (“Yes” branch from block 416), the server ends the transmission loop and allows the network connection to end (block 418). The server may also send additional instructions or messages to the first browser and the second browser confirming the user's intentions to end the web chat session.

The exemplary embodiments described herein can be implemented in digital electronic circuitry, or in computer hardware, firmware, software, or in combinations of them. The exemplary embodiments described herein can be implemented as a computer program product, i.e., a computer program tangibly embodied in an information carrier, e.g., in a machine-readable storage device or in a propagated signal, for execution by, or to control the operation of, communications processing apparatus, e.g., a processing device, a computer, or multiple computers. A computer program can be written in any form of programming language, including compiled, assembled, or interpreted languages, and it can be deployed in any form, including as a stand-alone program or as a module, component, subroutine, or other unit suitable for use in a computing environment. A computer program can be deployed to be executed on one computer or on multiple computers at one site or distributed across multiple sites and interconnected by a communication network.

The present invention is not intended to be limited to a device or method which must satisfy one or more of any stated or implied object or feature of the invention and is not limited to the preferred, exemplary, or primary embodiment(s) described herein. Modifications and substitutions by one of ordinary skill in the art are considered to be within the scope of the present invention.

The invention claimed is:

1. A method of managing a network connection using a connectionless, file-transferring protocol comprising:
transmitting periodically a browser executable script from a first node of a network to a second node of the network;
running the browser executable script with a browser of the second node; and
transmitting one or more information requests from the second node to the first node wherein transmitting information requests from the second node maintains a communication link with the first node and the second node until a trigger event occurs.

2. The method of claim 1, wherein a uniform resource locator of the first node is a parameter of the browser executable script.

3. The method of claim 1, wherein the connectionless, file-transferring protocol is hypertext transfer protocol.

4. The method of claim 1, wherein the browser executable script is a Javascript function.

5. The method of claim 1, wherein the network connection is a web chat session.

6. The method of claim 1, wherein the trigger event is an amount of time, a command provided by a user of the network connection, or a request by the first node.

7. A system of managing a network connection using a connectionless, file-transferring protocol comprising:
a first node on a network having a first browser for sending and receiving information on the network;
a second node on the network having a second browser for sending and receiving information on the network; and
a server on the network for sending and receiving information using the file-transfer protocol to the first browser of the first node and the second browser of the second node wherein the server periodically sends a browser executable script to the first node and second node causing the first browser and the second browsers to request information from the server on the network until a trigger event occurs.

8. The system of claim 7, wherein a uniform resource locator of the server is a parameter of the browser executable script.

9. The system of claim 7, wherein the connectionless, file-transferring protocol is hypertext transfer protocol.

10. The system of claim 7, wherein the browser executable script is a Javascript function.

11. The system of claim 7, wherein the network connection is a web chat session.

12. The system of claim 7, wherein the trigger event is an amount of time, a command provided by a user of the network connection, or a request by the server.

13. The system of claim 7, wherein transmitting requests for information from the first node to the server maintains a communication link with the server and the first node until a trigger event occurs and transmitting requests for information from the second node to the server maintains a communication link with the server and the second node until a trigger event occurs.

14. A method of managing a network connection using a connectionless, file-transferring protocol comprising:
transmitting information from a first computer on a network to a server on the network;
transmitting information from a second computer on the network to the server;
transmitting periodically a browser executable script from the server to the first computer and second computer;
running the browser executable script with a first browser of the first computer and a second browser of the second computer;
transmitting one or more information requests from the first computer to the server wherein transmitting of information requests from the first computer maintains a first communication link with the server and the first computer until a trigger event occurs; and
transmitting information requests from the second computer to the server wherein transmitting of information requests from the second computer maintains a second communication link with the server and the second computer until the trigger event occurs.

15. The method of claim 14, wherein a uniform resource locator of the server is a parameter of the browser executable script.

16. The method of claim 14, wherein the connectionless, file-transferring protocol is hypertext transfer protocol.

17. The method of claim 14, wherein the browser executable script is a Javascript function.

18. The method of claim 14, wherein the network connection is a web chat session.

19. The method of claim 14, wherein the trigger event is an amount of time, a command provided by a user of the network connection, or a request by the server.
